(19) United States
(12) Patent Application Publication
(10) Pub. No.: US 2025/0026392 A1
(43) Pub. Date: Jan. 23, 2025

(54) HANDCART

(71) Applicant: ISUZU MOTORS LIMITED, Yokohama-shi (JP)

(72) Inventor: Hayao KIMURA, Fujisawa-shi (JP)

(21) Appl. No.: 18/748,449

(22) Filed: Jun. 20, 2024

(30) Foreign Application Priority Data
Jul. 20, 2023 (JP) 2023-118387

(51) Int. Cl. B62B 3/06; B60B 19/00; B62B 5/04

(52) U.S. Cl. CPC B62B 3/06; B60B 19/003; B62B 5/049; B62B 2301/25

(57) ABSTRACT

An object of the present disclosure is to provide a handcart that is easy to finely adjust the direction even when loaded with a heavy object. For this purpose, the handcart includes: a platform; a handle erected on a rear of the platform; a pair of left and right fixed wheels disposed on a front of a lower surface of the platform; and a pair of left and right omni-directional wheels disposed on a rear of the lower surface of the platform.

### CROSS REFERENCE TO RELATED APPLICATIONS

This application is entitled to (or claims) the benefit of Japanese Patent Application No. 2023-118387, filed on Jul. 20, 2023, the disclosure of which including the specification, drawings and abstract is incorporated herein by reference in its entirety.

### TECHNICAL FIELD

The present disclosure relates to a handcart, and more particularly, to a handcart suitable for transporting heavy objects.

### BACKGROUND ART

A conventional handcart, for example, as disclosed in Patent Literature (hereinafter, referred to as “PTL”) 1 includes a plurality of wheels, generally four wheels, on a lower surface of a platform, and is provided with a handle erected on a rear side of the platform. The wheels include a wheel which is swivelable about a vertical axis (hereinafter referred to as a “swivel wheel”), and a wheel which is not swivelable about the vertical axis and is fixed in a direction (hereinafter referred to as a “fixed wheel”). The swivel wheels and the fixed wheels are used in appropriate combination such as the swivel wheels for all the wheels, swivel wheels for the front wheels and fixed wheels for the rear wheels, and fixed wheels for the front wheels and swivel wheels for the rear wheels.

### CITATION LIST

### Patent Literature

PTL 1: Japanese Patent Application Laid-Open No. 2020-073367

### SUMMARY OF INVENTION

### Technical Problem

Incidentally, when the direction of a handcart is changed by operating a handle in a case where the front wheels are swivel wheels 15 and the rear wheels are fixed wheel 7, a front portion of the handcart is swiveled to the left or right around rear portion O1 of the handcart by applying forces P1 and P2 in the front-rear direction to handle 5 with the left and right hands as illustrated in FIG. 4. On the other hand, when the front wheels are fixed wheels 7 and the rear wheels are swivel wheels 15, the rear portion of the handcart is swiveled to the left or right around front portion O2 of the handcart by applying lateral force Q to handle 5 as illustrated in FIG. 5. A distance from a swivel center to the position of the hand that operates handle 5 is longer in the latter case. Thus, the direction change can be made with a light force when a relatively heavy load is placed, and the operability is higher.

In the case where all the wheels are the swivel wheels, both the swivel around the front portion of the handcart and the swivel around the rear portion are possible to change the direction of the handcart, but the straight travel stability tends to decrease.

Therefore, when a relatively heavy load is carried, a handcart with fixed front wheels and swivel rear wheels may be selected.

When the direction of the handcart with the front wheels being the fixed wheels and the rear wheels being the swivel wheels is changed at a present place, the movement of swivel wheels 15 is as illustrated in FIGS. 6 and 7. When handle 5 is moved upward in the figure, the rear portion of the handcart moves upward in the figure around the front portion of the handcart (FIG. 6). At this time, each of swivel wheels 15 swivels downward around a swivel axis near the front end thereof. Next, when handle 5 is moved downward in the figure, the rear portion of the handcart is moved downward in the figure around the front portion of the handcart (FIG. 7). At this time, each of swivel wheels 15 swivels upward about the swivel axis by 180 degrees. Therefore, there is a problem that, when handle 5 is swung to the left and right in order to finely adjust the direction of the handcart, swivel wheels 15 swivel nearly 180 degrees each time, and the movement of swivel wheels 15 is large and frictional resistance between swivel wheels 15 and the floor surface is also generated, which makes fine adjustment difficult. In particular, when a heavy object is placed on a platform, it is more difficult to finely adjust the direction of the handcart.

An object of the present disclosure is to provide a handcart that is easy to finely adjust the direction even when loaded with a heavy object.

### Solution to Problem

A handcart of the present disclosure includes: a platform; a handle erected on a rear of the platform; a pair of left and right fixed wheels disposed on a front of a lower surface of the platform; and a pair of left and right omni-directional wheels disposed on a rear of the lower surface of the platform. Here, the omni-directional wheels mean wheels capable of rolling in any direction without changing the direction by swiveling the wheels around the vertical axis.

Further, the handcart of the present disclosure includes a stopper disposed on the rear of the platform to be vertically movable, the stopper being positioned above lower ends of the omni-directional wheels in a raised position, and positioned below the lower ends of the omni-directional wheels in a lowered position.

Further, in the handcart of the present disclosure, a cover surrounding the omni-directional wheels is disposed on the platform.

Further, the handcart of the present disclosure further includes a pair of left and right omni-directional wheels disposed substantially on a middle of the lower surface of the platform in a front-rear direction.

Further, in the handcart of the present disclosure, the omni-directional wheels are omni-wheels.

### Advantageous Effects of Invention

According to the handcart of the present disclosure, since the front wheels are fixed wheels and the rear wheels are omni-directional wheels, it is possible to finely adjust the direction with a light force without resistance such as that in the case of a swivel wheel during swivel, while securing the straight traveling stability, even when a heavy object is placed on the handcart. In addition, the straight traveling stability is superior to that in the case where all the wheels are the omni-directional wheels.

Further, by disposing the stopper on the rear of the platform, the handcart is supported by the fixed wheels and the stopper at the time of stopping, and the posture is thus stabilized.

Also, the cover surrounding the omni-directional wheels eliminates a risk of causing a user's foot to be caught in the omni-directional wheels.

Further, the omni-directional wheels disposed substantially on the middle of the lower surface of the platform in the front-rear direction make it possible to distribute a load acting on the wheels. It is thus possible to employ relatively smaller omni-directional wheels even from among the omni-directional wheels with a complicated structure, so as to keep the total height of the handcart low.

Further, by using the omni-wheels as the omni-directional wheels, fine adjustment of the position of the handcart becomes smoother.

### BRIEF DESCRIPTION OF DRAWINGS

FIG. 1 is a trimetric projection (front) of a handcart;

FIG. 2 is a trimetric projection (rear) of the handcart;

FIG. 3 is a bottom view of the handcart;

FIG. 4 is a bottom view illustrating an operation of the prior art;

FIG. 5 is a bottom view illustrating the operation of the prior art;

FIG. 6 is a bottom view illustrating the operation of the prior art; and

FIG. 7 is a bottom view illustrating the operation of the prior art.

### DESCRIPTION OF EMBODIMENTS

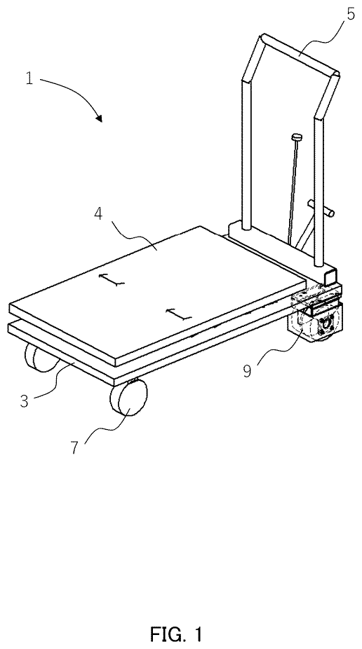

Hereinafter, a handcart according to an embodiment of the present disclosure will be described with reference to the drawings. Note that, in the present specification, the direction in which a handcart travels by a user pushing a handle is described as a front direction, the opposite direction is described as a rear direction, and the left-right direction with respect to the front direction is described as a lateral direction. In FIG. 1, handcart 1 includes vehicle main body 3, platform 4 movable up and down with respect to vehicle main body 3, handle 5 erected in the rear of vehicle main body 3, fixed wheels 7 disposed in the front of the lower surface of vehicle main body 3, and omni-directional wheels 9 disposed in the rear of the lower surface of vehicle main body 3.

Platform 4 is configured to be movable up and down with respect to vehicle main body 3 by a link mechanism, an actuator, and/or the like.

Handle 5 has a gate shape formed by a pair of left and right pillars and a handlebar disposed on the upper ends of the pillars.

Fixed wheels 7 are wheels whose direction is fixed in the front-rear direction.

Generally so-called omni-wheels or mechanum wheels can be employed as omni-directional wheels 9, and the present embodiment employs omni-wheels in which a peripheral edge portion of a rotating member rotatable in the front-rear direction about an axis of the lateral direction is provided with multiple small rollers whose rotation axes are oriented in the circumferential direction of the rotating member.

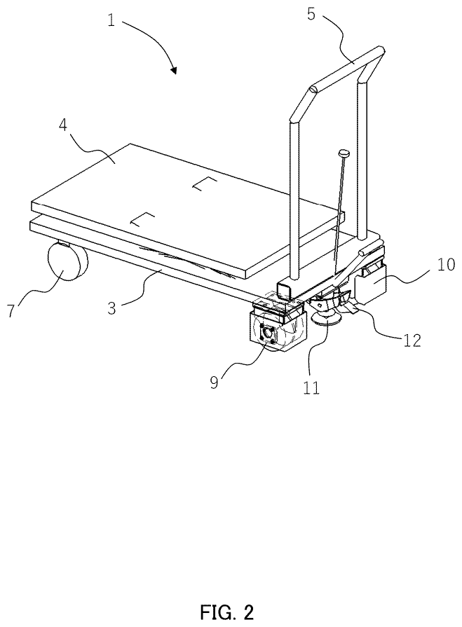

In FIG. 2, covers 10 are disposed in the rear of vehicle main body 3 so as to surround omni-directional wheels 9 in order to prevent a foot of the user from making contact with omni-directional wheels 9. Covers 10 are plate-shaped members formed so as to cover around omni-directional wheels 9. In addition, stopper 11 for preventing movement of handcart 1 is disposed at the center of the rear portion of vehicle main body 3. Stopper 11 is configured to be raised and lowered with respect to vehicle main body 3 so as to be positioned above the lower ends of omni-directional wheels 9 in the raised position and protrude below the lower ends of omni-directional wheels 9 in the lowered position. A front end portion of lever 12 is pivotally supported so as to be movable up and down with respect to vehicle main body 3, and an intermediate portion thereof is pivotally attached to stopper 11. Further, the rear end portion of lever 12 is formed in a flat plate shape so as to be able to perform a pedaling operation.

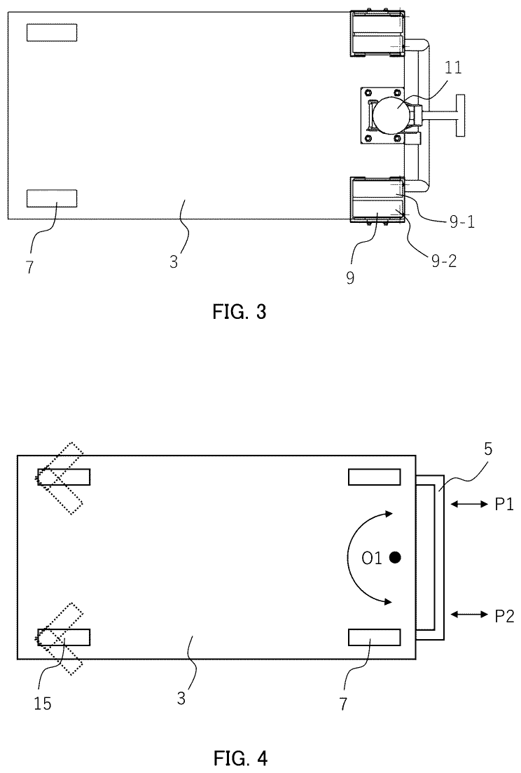

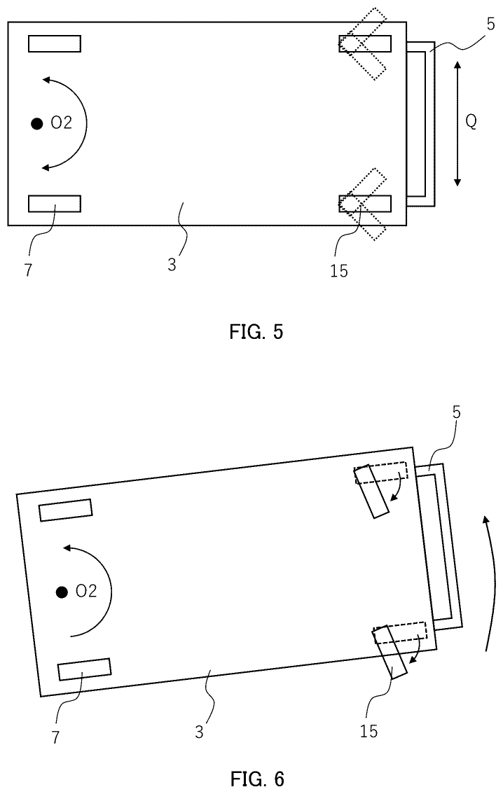

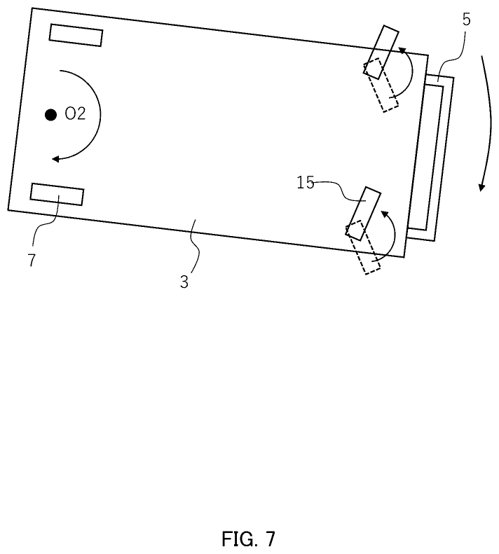

FIG. 3 is a bottom view of handcart 1. The pair of left and right fixed wheels 7 are disposed in the front (the left side in the figure) of vehicle main body 3, and the pair of left and right omni-directional wheels 9 are disposed in the rear (the right side in the figure) of vehicle main body 3. In the illustrated example, omni-directional wheels 9 are a pair of left and right omni-wheels, each of which is composed of two omni-directional wheels 9-1 and 9-2. That is, there are a total of four omni-directional wheels. Stopper 11 is disposed between left and right omni-directional wheels 9.

Next, the operation of handcart 1 will be described. Stopper 11 is lowered to stabilize handcart 1 before a load is placed on platform 4. By operating lever 12, stopper 11 is lowered below the lower ends of omni-directional wheels 9. When stopper 11 comes into contact with the floor surface, the rear side of the vehicle body is relatively raised, and omni-directional wheels 9 are separated from the floor surface. At this time, handcart 1 is supported on the floor surface by a pair of left and right fixed wheels 7 and stopper 11. The movement in the front-rear direction is blocked by stopper 11, and the movement in the left-right direction is blocked by fixed wheels 7 and stopper 11. Therefore, handcart 1 is prevented from being inadvertently moved during when the load is loaded.

After the load is placed on platform 4, stopper 11 is raised, and the rear end of handcart 1 is lowered to ground omni-directional wheels 9. Then, the user operates handle 5 to convey the load to a predetermined place. Since the front wheels are fixed wheels 7, the direction is stable when moving straight, and since the rear wheels are omni-directional wheels 9, steering is light and easy when a heavy object is conveyed.

Upon arrival at a destination, handcart 1 is operated and positioned at a parking position. When the direction of handcart 1 is adjusted by swinging handle 5 to the left and right, swivel resistance of the wheels is not caused since the rear wheels are omni-directional wheels 9, and smooth adjustment is thus possible.

When the position adjustment is completed, stopper 11 is lowered by operating lever 12 to raise the rear end of handcart 1, and omni-directional wheels 9 are separated from the floor surface to prevent the movement of handcart 1.

### (Variations)

Although the above example adopts a two-axes configuration in which the front wheels are the fixed wheels and the rear wheels are the omni-directional wheels, a three-axes configuration may be used in which additional omni-directional wheels may be disposed in the middle in the front-rear direction. As compared with the fixed wheels and swivel wheels, the structure of the omni-directional wheels includes small parts and is more complicated, causing a reduced load bearing capacity. In order to increase the load bearing capacity of the omni-directional wheels, it is necessary to enlarge the entire wheel, which increases the vehicle height and increases the burden on loading and unloading a load. Therefore, by increasing the number of axes of the wheels, the maximum loading weight of the handcart can be increased while keeping the vehicle height low, without enlarging the omni-directional wheels.

While the embodiments have been described with reference to the drawings, the present disclosure is not limited thereto. The omni-directional wheels may be of other types, such as mechanum wheels, as long as they can move laterally without swiveling the wheels about a vertical axis. Although the above example has been described as a manually-operated handcart, the handcart may be of a type having a driving source to assist a driving force.

### INDUSTRIAL APPLICABILITY

According to the handcart of the present disclosure, it is possible to easily adjust the position of a load at the time of load transportation.

### REFERENCE SIGNS LIST

1 Handcart
3 Vehicle main body
4 Platform
5 Handle
7 Fixed wheel
9 Omni-directional wheel (omni-wheel)
10 Cover
11 Stopper
12 Lever
15 Swivel wheel

1. A handcart, comprising:
a platform;
a handle erected on a rear of the platform;
a pair of left and right fixed wheels disposed on a front of a lower surface of the platform; and
a pair of left and right omni-directional wheels disposed on a rear of the lower surface of the platform.

2. The handcart according to claim 1, further comprising:
a stopper disposed on the rear of the platform to be vertically movable, the stopper being positioned above lower ends of the omni-directional wheels in a raised position and positioned below the lower ends of the omni-directional wheels in a lowered position.

3. The handcart according to claim 1, wherein
a cover surrounding the omni-directional wheels is disposed on the platform.

4. The handcart according to claim 1, further comprising:
a pair of left and right omni-directional wheels disposed substantially on a middle of the lower surface of the platform in a front-rear direction.

5. The handcart according to claim 1, wherein
the omni-directional wheels are omni-wheels.
